(19) United States
(12) Patent Application Publication
(10) Pub. No.: US 2003/0142695 A1
(43) Pub. Date: Jul. 31, 2003

(54) Method and apparatus for transmitting/receiving leased line data

(76) Inventors: Hoon Lee, Daejon (KR); Je-Soo Ko, Daejon (KR); Tae-Whan Yoo, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/188,427

(22) Filed: Jul. 2, 2002

(30) Foreign Application Priority Data
Jan. 25, 2002 (KR) 2002-4420

(51) Int. Cl. H04J 1/00

(52) U.S. Cl. 370/485; 370/493

(57) ABSTRACT

A method for transmitting and receiving leased line data, an apparatus for transmitting leased line data, and an apparatus for receiving leased line data are provided. The method includes storing received leased line data in a FIFO; packing the leased line date stored in the FIFO into the payload of a DSL frame; and transmitting the packed DSL frame. According to the method, leased line data can be transparently transmitted by adding minimum function blocks to the DSL modem, and with the simple circuit structure, the blocks can be integrated into one chip such that no additional external circuits are needed and a low-priced DSL modem chip that can transmit leased line data can be implemented.

### BACKGROUND OF THE INVENTION

1. Field of the Invention

The present invention relates to a method and apparatus for transmitting/receiving leased line data such as T1 and E1 data, using a DSL frame, and more particularly, to a method and apparatus for transparently transmitting/receiving leased line data, using a DSL frame.

2. Description of the Related Art

At present, most DSL modems support changing data transmission speed according to the environment of a channel. Therefore, it is appropriate to ATM data transmission, but it is not appropriate to leased line data transmission in which a fixed data transmission speed should be supported. However, since the DSL modem can support high-speed data transmission, and is placed at the subscriber side terminal, demands for the DSL modem supporting a variety of user interface in addition to the ATM data transmission are increasing, and the leased line data transmission is one of the most important services the DSL modem should provide.

Data interface between the ATM having a variable data transmission speed and the leased line having a fixed data transmission speed is a prerequisite for satisfying the demands. In the prior art data interfaces, there are a method in which data is processed using a Digital Signal Processor (DSP) that is disclosed in U.S. Pat. No. 6,178,180, entitled “Communications Adapter For Processing ATM and ISDN data,” and a method which is disclosed in Korea Patent Laid-open Gazette (1997 Patent Application No. 28587), and in which data having a fixed speed are packed in an ATM cell payload.

FIG. 1 is a block diagram of an apparatus for matching a subscriber apparatus to ISDN and ATM networks, using the DSP disclosed in the U.S. Pat. No. 6,178,180, in which the subscriber apparatus transmits data through a PCI bridge, the data is processed by using the DSP, and the processed data is sent to an ISDN network or an ATM network through an SC bus switch. Also, a matching circuit for ATM network matching and a matching circuit for ISDN network matching are connected to the SC bus switch. Thus, the matching apparatus shown in FIG. 1 can connect a user computer having a PCI interface to an ISDN or ATM network, by processing user data with using the DSP, memories, and additional function blocks. However, since the DSP and RAM buffers are used excessively for processing data in this matching apparatus, it is difficult to integrate the DSP and RAM buffers in one DSL modem chip, and to produce a low-priced model.

FIG. 2 shows a technology for extracting data desired to be transmitted from the DS3 level data trunk disclosed in the Korea Patent Laid-open Gazette (1997 Patent Application No. 28587), and packing the extracted data in an ATM cell. Here, the DS3 data is transmitted to a DS3 trunk matching unit through a DS3 trunk, the DS3 trunk matching unit determines whether or not there is an error in the transmitted DS3 data, extracts clocks, and then transmits the data to MUX/DEMUX. The MUX/DEMUX checks whether or not there is disorder in the DS3 frame, divides the DS3 frame into 28 T1 signals, and then transmits the T1 signals to AAL1 SAR processor. In the AAL1 SAR processor, each processor makes 8 T1 lines into ATM cells, by making each T1 line into an ATM cell, and stores the ATM cells in a first FIFO. At this time, the ATM cell MUX/DEMUX sequentially inputs the ATM cells stored in the first FIFO, and transmits the ATM cells to an ATM routing table. The ATM routing table converts the ATM cells into switch heads used in an ATM switch, and transmits the switch heads to the ATM switch. However, this matching apparatus also needs the AAL1 SAR processor and additional function blocks that need a lot of hardware, and it is difficult to provide low-priced products. Also, by using a method packing DS3 data in an ATM cell, overall throughput is lowered.

### SUMMARY OF THE INVENTION

To solve the above problems, it is an objective of the present invention to provide a simplified circuit for transmitting leased line data through a DSL modem, by transparently packing leased line data into a frame payload of the DSL modem such that data processing with the DSP or packing data into an ATM cell is not needed.

To accomplish the objective of the present invention, there is provided a method for transmitting leased line data comprising storing received leased line data in a FIFO; packing the leased line date stored in the FIFO into the payload of a DSL frame; and transmitting the packed DSL frame.

It is preferable that the step for packing the leased line data stored in the FIFO into the payload of a DSL frame comprises inserting a predetermined idle pattern into the payload of the DSL frame if leased line data is not available in the FIFO; and inserting information indicating the size of leased line data into the payload of the DSL frame payload.

It is preferable that the step for packing the leased line data stored in the FIFO in the payload of a DSL frame further comprises inserting information indicating that data packed in the DSL frame payload is leased line data.

It is preferable that the predetermined idle pattern is the data that is generated from the final effective leased line data packed into the DSL frame payload.

To accomplish the objective of the present invention, there is provided another method for receiving leased line data comprising receiving a DSL frame in which leased line data is packed; unpacking the leased line data from the received DSL frame payload; and sending the unpacked leased line data to a FIFO.

It is preferable that the step for unpacking the leased line data from the received DSL frame payload comprises detecting a predetermined idle pattern from the DSL frame payload; and discarding the detected predetermined idle pattern.

It is preferable that the predetermined idle pattern is generated by using the final effective leased line data which is packed into the DSL frame payload.

It is preferable that the method further comprises checking a transmission error, using information which is included in the received DSL frame payload, and indicates the size of leased line data packed in the payload.

It is preferable that the step for checking a transmission error comprises comparing the size of unpacked leased line data, excluding information indicating the size of the leased line data contained in the DSL frame payload, and predetermined idle patterns in the DSL frame payload.

Also, to accomplish the first objective of the present invention, there is provided apparatus for transmitting leased line data comprising a FIFO which stores received leased line data; and a packing unit which packs leased line data stored in the FIFO into the payload of a DSL frame.

It is preferable that the packing unit comprises an idle pattern inserting unit which inserts a predetermined idle pattern into the payload of the DSL frame if leased line data is not available when leased line data stored in the FIFO is packed into the payload of the DSL frame, in which information indicating the size of leased line data packed in the DSL frame payload excluding the size of the predetermined idle pattern is inserted into the DSL frame payload.

It is preferable that predetermined idle pattern is generated by using the final effective leased line data which is packed into the DSL frame payload.

Also, to accomplish the first objective of the present invention, there is provided an apparatus for receiving leased line data comprising an unpacking unit which receives a DSL frame in which leased line data is packed and unpacks leased line data from the payload of the DSL frame; and a FIFO which stores the leased line data unpacked in the unpacking unit.

It is preferable that the unpacking unit comprises an idle pattern detection unit which if a predetermined idle pattern is detected when leased line data is unpacked from the DSL frame payload, discards the detected predetermined idle pattern, in which a data transmission error is checked by using information indicating the size of leased line data packed in the DSL frame payload.

It is preferable that the predetermined idle pattern is generated by using the final effective leased line data which is packed in the DSL frame payload.

Also, to accomplish the first objective of the present invention, there is provided an apparatus for transmitting/receiving leased line data comprising a FIFO which stored leased line data; and a DSL frame generating unit which comprises a packing unit which packs leased line data stored in the FIFO into a DSL frame payload, and an unpacking unit which unpacks leased line data from the DSL frame payload.

It is preferable that the packing unit comprises an idle pattern inserting unit which inserts a predetermined idle pattern into the payload of the DSL frame if leased line data is not available while the leased line data stored in the FIFO is packed into the payload of the DSL frame, in which information indicating the size of leased line data packed in the DSL frame payload excluding the size of the predetermined idle pattern is inserted into the DSL frame payload; and the unpacking unit comprises an idle pattern detection unit which if a predetermined idle pattern is detected when leased line data is unpacked from the DSL frame payload, discards the detected predetermined idle pattern, in which a data transmission error is checked by using information indicating the size of leased line data packed in the DSL frame payload.

It is preferable that the apparatus further comprises a serial/parallel converting unit which converts received leased line data from serial data to parallel data and then sends the data to the FIFO, or converts received leased line data which is sent by the FIFO, from parallel data to serial data.

### BRIEF DESCRIPTION OF THE DRAWINGS

The above objects and advantages of the present invention will become more apparent by describing in detail preferred embodiments thereof with reference to the attached drawings in which:

FIG. 1 is a block diagram of a prior art subscriber apparatus and a communications adapter interfacing ISDN and ATM networks;

FIG. 2 is a block diagram of an apparatus for matching prior art DS3 level data to an ATM network;

FIG. 3 is a block diagram of an example of an apparatus for packing/unpacking leased line data so that the leased line data can be transmitted through a DSL modem according to the present invention;

FIG. 4 is a block diagram of the detailed structure of a DSL frame generating unit in the apparatus shown in FIG. 3;

FIG. 5 is a block diagram of an example of a DSL frame according to the present invention;

FIG. 6 is a flowchart of a process for transmitting a DSL frame after packing received leased line data; and

FIG. 7 is a flowchart of a process for unpacking leased line data after receiving a DSL frame.

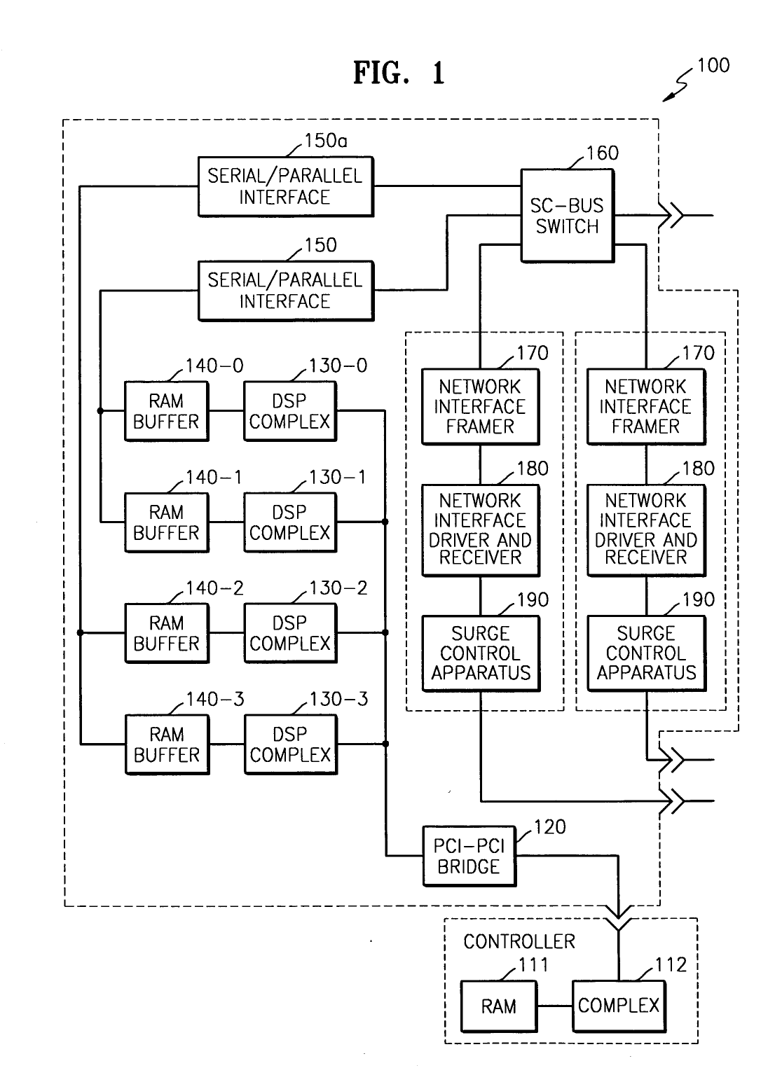

### DESCRIPTION OF THE PREFERRED EMBODIMENTS

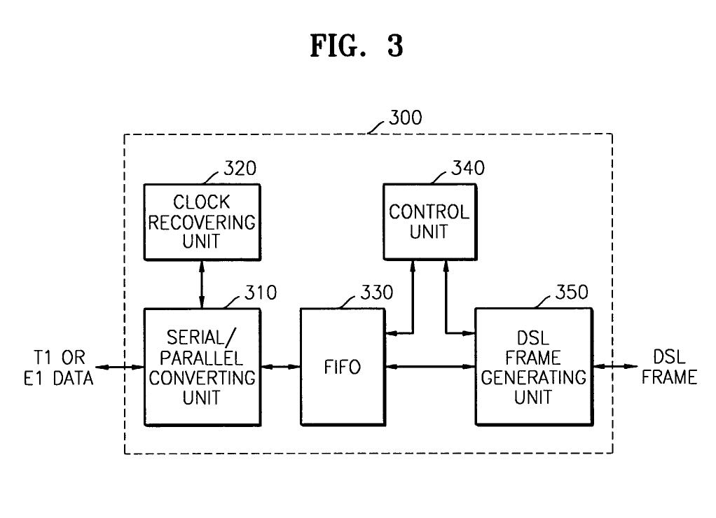

FIG. 3 is a block diagram of an example of an apparatus for packing/unpacking leased line data so that the leased line data can be transmitted through a Digital Subscriber Line (DSL) modem according to the present invention.

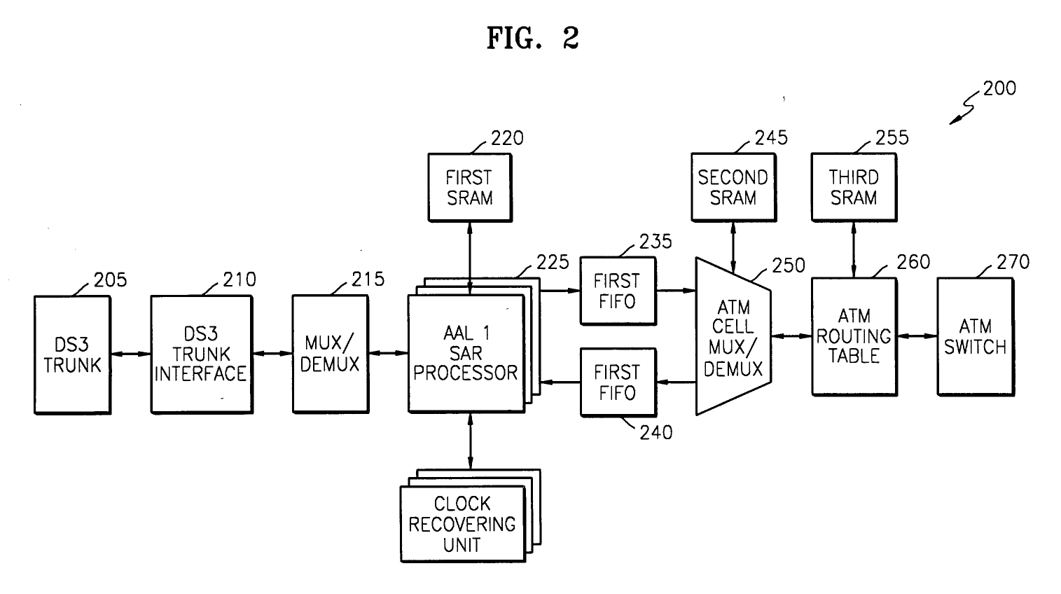

The apparatus for packing/unpacking leased line data shown in FIG. 2 has a serial/parallel converting unit 310, a clock recovering unit 320, a FIFO 330, a control unit 340, and a DSL frame generating unit 350. The serial/parallel converting unit 310 converts serial leased line data (T1 or E1 data) which is transmitted by a transmitting unit at a fixed speed, into parallel data and sends the data in units of byte to the FIFO 330. The clock recovering unit 320 synchronizes data which are sent to the serial/parallel converting unit, with a T1 or E1 clock.

In transmitting a DSL frame, the input clock of the FIFO 330 is a 1/8 synchronization clock of the T1 or E1 clock, and the output clock is a frame byte clock of the DSL modem. Likewise, in receiving a DSL frame, the output clock of the FIFO 330 is a 1/8 synchronization clock of the T1 or E1 clock.

Thus, the input clock and output clock of a FIFO are generally different to and asynchronous with each other. Therefore, in order to pack T1 or E1 data into a DSL frame payload, a FIFO having the same byte unit as the size of the DSL frame payload is needed.

The control unit 340 controls the apparatus so that leased line data is output from the FIFO 330 to the DSL frame generating unit 350, and leased line data is extracted from a received DSL frame.

The DSL frame generating unit 350 fetches leased line data stored in the FIFO 330 and packs the data into the payload of a DSL frame.

The detailed structure of the DSL frame generating unit 350 is shown in FIG. 4. The DSL frame generating unit has a frame packing unit having an idle pattern inserting unit 352, and a frame unpacking unit 353 having an idle pattern detection unit 354 and error checking unit 355.

The frame packing unit 351 fetches leased line data stored in the FIFO 330, and packs the data into the payload of a DSL frame. At this time, if the FIFO 330 is empty, that is, if leased line data is not available in the FIFO 330, an idle pattern is inserted into the payload.

The frame unpacking unit 353 unpacks leased line data from a received DSL frame. When the DSL frame is unpacked, the idle pattern detection unit 354 detects an idle pattern which is formed with the cascaded inverted version of an arbitrary data pattern and follows the arbitrary data pattern in leased line data. The error checking unit 355 checks the size of leased line data which is loaded on the current frame and received, by checking the last byte indicating the size of leased line data contained the payload. Then, the error checking unit 355 checks whether or not transmission is normally performed, by comparing the checked size with a data size which is counted in the actual unpacking process.

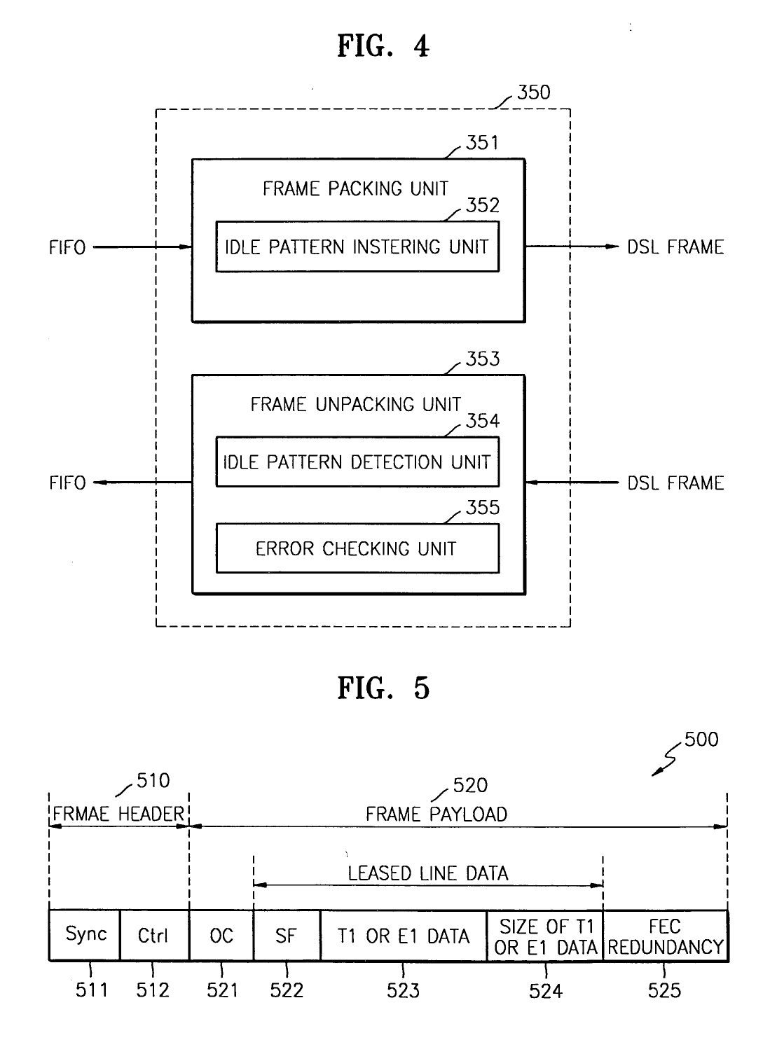

FIG. 5 shows the format of a DSL frame generated according to the present invention.

The DSL frame 500 is formed with a frame header 510 and a frame payload 5420. The frame header 510 has a synchronization field (Sync) 511, and a control field (Ctrl) 512. The frame payload 520 has an operation channel field 521, an SF field 522, a T1 or E1 data field 523, a leased line date size field 524, and an FEC redundancy field 525.

The SF field 522 having one byte size is used to indicate that the data which is currently transmitted is leased line data, and T1 or E1 data. Also, the leased line data size field 524 having one byte size is used to indicate the size of leased line data which is currently transmitted in a DSL frame, and the FEC redundancy field indicates redundancy which is generated in an RS encoding process. Leased line data to be packed is loaded into the T1 or E1 data field 523. The size of leased line data to be packed may be one of the values from minimum 0 byte and maximum (DSL frame payload size−(OC size+FEC redundancy+2)) bytes.

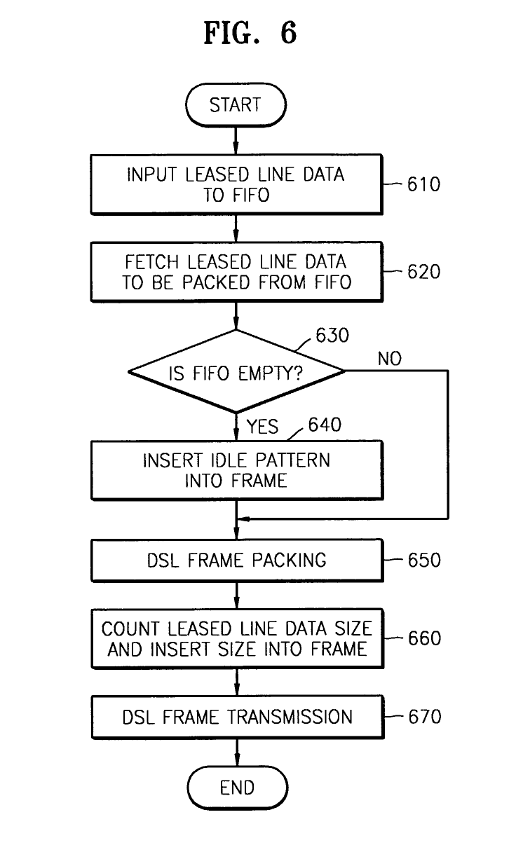

Referring to FIG. 6, a process for packing leased line data in a DSL frame and transmitting the data will now be explained.

T1 or E1 leased line data which is transmitted in a fixed data transmission speed is stored in a FIFO having a predetermined size in step S610. The DSL frame generating unit receives leased line data from the FIFO in order to generate a frame in step S620. At this time, the frame payload processing speed of the DSL modem should be set to a speed faster than the T1 or E1 data processing speed, and this can be done by the DSL modem which is designed to be capable changing the data transmission speed. In this environment, the FIFO output of the sending unit is faster than the input, and therefore, a FIFO empty state may occur in the DSL frame packing process.

Therefore, the frame packing unit 351 checks whether or not the FIFO is empty in step S360. If the FIFO is not empty, the frame packing unit 351 fetches leased line data from the FIFO and packs a frame in step S650 as a normal operation. If the FIFO is empty, the idle pattern inserting unit 352 of the frame packing unit 351 inserts an idle pattern into a DSL frame, and the idle pattern which is inserted at this time is the inverted version of a final effective data item packed in a DSL frame in step S640. If T1 or E1 data is input again when the FIFO is empty, the FIFO becomes an available state again, and therefore, the frame packing unit again fetches data and packs the data.

Leased line data is packed into a DSL frame through the above steps, and if the last byte of the payload of the DSL frame has arrived, the size of leased line data packed in the payload except the size of idle patterns is finally inserted in the last byte of the payload, that is, the leased line data size field 524. By doing so, the generation of the frame is completed in step S660. Then, the generated DSL frame is sent to the DSL modem in step S670.

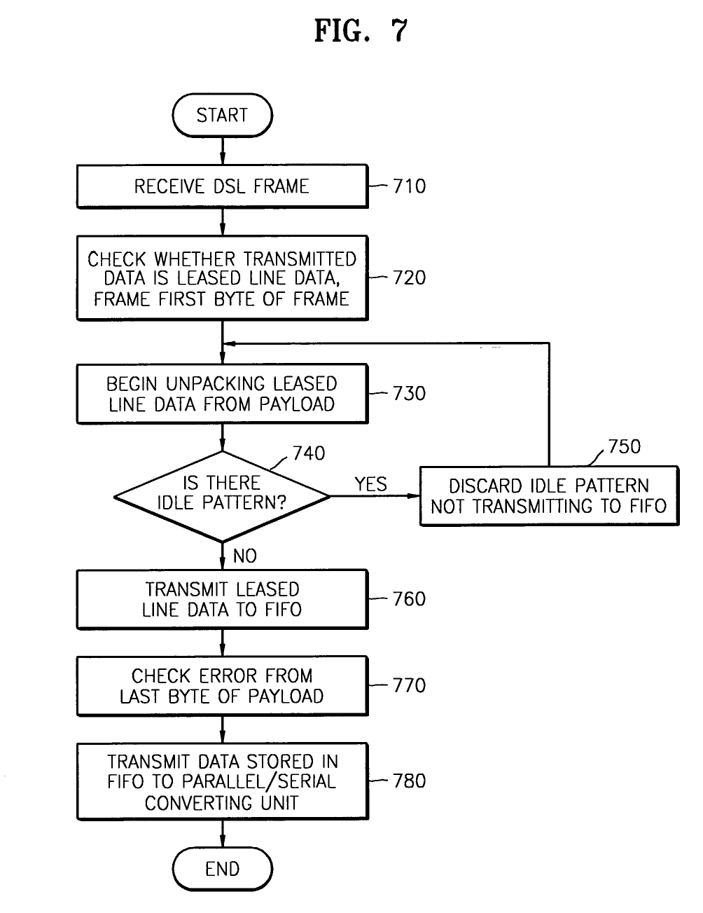

Referring to FIG. 7, a process for unpacking leased line data after receiving a DSL frame will now be explained. If a DSL frame is received in step S710, the frame unpacking unit 353 checks that the received data is leased line data, by checking the SF field 522 of the DSL frame payload in step S720, and begins unpacking leased line data of the payload in step S730.

The idle pattern detection unit 354 detects an idle pattern which is formed with the inverted version of a final arbitrary data pattern and follows the arbitrary data pattern in leased line data in step S740. If the pattern is not an idle pattern, the idle pattern detection unit 354 sends the received leased line data to the FIFO as a normal operation in step S760. If it is determined that the pattern is an idle pattern, the idle pattern detection unit 354 stops sending the idle pattern to the FIFO and discards the pattern in step S750, and then sending data to the FIFO begins again from a time when a pattern different from the inverted version occurs.

Next, by checking the last byte of the payload, the size of leased line data which is loaded in the current frame and transmitted is checked, and then, the checked size is compared with a data size which is counted in the actual unpacking process so as to check whether or not the transmission is normally performed in step S770.

The leased line data which is unpacked through the steps is stored in the FIFO, and is sent to the parallel/serial converting unit by using a clock generated from the clock recovering unit in step S780. The parallel/serial converting unit converts the received parallel data into serial data, and finally outputs data synchronized with the recovered clock.

As described above, according to the leased line data transmission apparatus and method using the DSL frame of the DSL modem of the present invention, leased line data can be transparently transmitted by adding minimum function blocks to the DSL modem, and with the simple circuit structure, the blocks can be integrated into one chip such that no additional external circuits are needed and a low-priced DSL modem chip that can transmit leased line data can be implemented.

What is claimed is:

1. A method for transmitting leased line data comprising:
storing received leased line data in a FIFO;
packing the leased line date stored in the FIFO into the payload of a DSL frame; and
transmitting the packed DSL frame.

2. The method of claim 1, wherein the step for packing the leased line data stored in the FIFO into the payload of a DSL frame comprises:
inserting a predetermined idle pattern into the payload of the DSL frame if leased line data is not available in the FIFO; and
inserting information indicating the size of leased line data into the payload of the DSL frame payload.

3. The method of claim 2, wherein the step for packing the leased line data stored in the FIFO in the payload of a DSL frame further comprises:
inserting information indicating that data packed in the DSL frame payload is leased line data.

4. The method of claim 2, wherein the predetermined idle is the data that is generated from the final effective leased line data packed into the DSL frame payload.

5. A method for receiving leased line data comprising:
receiving a DSL frame in which leased line data is packed;
unpacking the leased line data from the received DSL frame payload; and
sending the unpacked leased line data to a FIFO.

6. The method of claim 5, wherein the step for unpacking the leased line data from the received DSL frame payload comprises:
detecting a predetermined idle pattern from the DSL frame payload; and
discarding the detected predetermined idle pattern.

7. The method of claim 6, wherein the predetermined idle pattern is generated by using the final effective leased line data which is packed into the DSL frame payload.

8. The method of claim 6, further comprising:
checking a transmission error, using information which is included in the received DSL frame payload, and indicates the size of leased line data packed in the payload.

9. The method of claim 8, wherein the step for checking a transmission error comprises comparing the size of unpacked leased line data, excluding information indicating the size of the leased line data contained in the DSL frame payload, and predetermined idle patterns in the DSL frame payload.

10. An apparatus for transmitting leased line data comprising:
a FIFO which stores received leased line data; and
a packing unit which packs leased line data stored in the FIFO into the payload of a DSL frame.

11. The apparatus of claim 10, wherein the packing unit comprises:
an idle pattern inserting unit which inserts a predetermined idle pattern into the payload of the DSL frame if leased line data is not available while the leased line data stored in the FIFO is packed into the payload of the DSL frame, wherein information indicating the size of leased line data packed in the DSL frame payload excluding the size of the predetermined idle pattern is inserted into the DSL frame payload.

12. The apparatus of claim 11, wherein predetermined idle pattern is generated by using the final effective leased line data which is packed into the DSL frame payload.

13. An apparatus for receiving leased line data comprising:
an unpacking unit which receives a DSL frame in which leased line data is packed and unpacks leased line data from the payload of the DSL frame; and
a FIFO which stores the leased line data unpacked in the unpacking unit.

14. The apparatus of claim 13, wherein the unpacking unit comprises:
an idle pattern detection unit which if a predetermined idle pattern is detected when leased line data is unpacked from the DSL frame payload, discards the detected predetermined idle pattern, wherein a data transmission error is checked by using information indicating the size of leased line data packed in the DSL frame payload.

15. The apparatus of claim 14, wherein the predetermined idle pattern is generated by using the final effective leased line data which is packed in the DSL frame payload.

16. An apparatus for transmitting/receiving leased line data comprising:
a FIFO which stored leased line data; and
a DSL frame generating unit which comprises a packing unit which packs leased line data stored in the FIFO into a DSL frame payload, and an unpacking unit which unpacks leased line data from the DSL frame payload.

17. The apparatus of claim 16, wherein the packing unit comprises an idle pattern inserting unit which inserts a predetermined idle pattern into the payload of the DSL frame if leased line data is not available when leased line data stored in the FIFO is packed into the payload of the DSL frame, wherein information indicating the size of leased line data packed in the DSL frame payload excluding the size of the predetermined idle pattern is inserted into the DSL frame payload; and
the unpacking unit comprises an idle pattern detection unit which if a predetermined idle pattern is detected when leased line data is unpacked from the DSL frame payload, discards the detected predetermined idle pattern, wherein a data transmission error is checked by using information indicating the size of leased line data packed in the DSL frame payload.

18. The apparatus of claim 16, further comprising:
a serial/parallel converting unit which converts received leased line data from serial data to parallel data and then sends the data to the FIFO, or converts received leased line data which is sent by the FIFO, from parallel data to serial data.
